(19) United States
(12) Patent Application Publication
(10) Pub. No.: US 2025/0342421 A1
(43) Pub. Date: Nov. 6, 2025

(54) SYSTEM FOR ORDERING, PREPARING AND SERVING BEVERAGES IN A CROWDED BAR ENVIRONMENT

(71) Applicant: Milian Seeve, Upper Montclaire, NJ (US)

(72) Inventor: Milian Seeve, Upper Montclaire, NJ (US)

(21) Appl. No.: 19/197,424

(22) Filed: May 2, 2025

Related U.S. Application Data
(60) Provisional application No. 63/641,603, filed on May 2, 2024.

(51) Int. Cl. G06Q 10/0631; G06Q 30/0601; G06Q 50/12

(52) U.S. Cl. CPC G06Q 10/06312; G06Q 30/0603; G06Q 30/0631; G06Q 30/0639; G06Q 50/12

(57) ABSTRACT

The present invention relates to a system and method for enhancing operational efficiency within service industry businesses, through the use of a mobile, computer, or web-based application. The system comprises a customer-side and a business-side interface designed to streamline the ordering, preparation, payment, inventory management, and delivery processes. The customer interface enables users to browse local venues, view occupancy and wait times, place customized orders, make payments, receive real-time order updates, and utilize location-based services. The business interface facilitates order reception, categorization, and queuing based on predefined item complexity levels, enabling staff to batch-process similar items. Additional features include staff-specific work batching, real- time order status tracking, lockbox-based order pickup, virtual queuing for in-person service, targeted promotions, and automated payment processing with optional tipping and payment splitting. The invention leverages user profiles, GPS integration, and intelligent order management to optimize service delivery, minimize workload, and improve customer experience.

### REFERENCE TO RELATED APPLICATION

This application claims the benefit of U.S. Provisional Application No. 63/641,603. The foregoing application is incorporated herein by reference in their entireties.

### FIELD OF THE INVENTION

The present invention relates generally to an application for increasing efficiency of bars, restaurants and other service industries through remote orders and payment by patrons and optimized order queues for staff.

### GENERAL BACKGROUND

Crowded bars present numerous challenges for both patrons and staff. Long wait times to place orders, difficulty communicating with bartenders, and overcrowded spaces can diminish the enjoyment of patrons and hinder the efficiency of bar operations. The traditional method of walking up to the bar to order a drink creates a bottleneck. There is a longstanding need to improve this age-old problem. The present invention provides a solution through a mobile and computer based application system.

### SUMMARY OF THE INVENTION

In accordance with some embodiments, the present invention is an application for ordering, categorizing, queuing and serving food and beverages in bar that improves efficiency and customer experience especially in a crowded bar setting.

### BRIEF DESCRIPTION OF THE DRAWINGS

The foregoing and other objects, features, and advantages of the invention are apparent from the following detailed description taken in conjunction with the accompanying drawings in which like parts are given like reference numerals and, wherein:

FIG. 1 depicts a customer-side application screen displaying a list of bars and restaurants in accordance with embodiments of the invention.

FIG. 2 depicts a business-side application screen displaying a queue of customer orders in accordance with embodiments of the invention.

FIG. 3 depicts a business-side application screen displaying customer orders organized by category of drink in accordance with embodiments of the invention.

FIG. 4 depicts a selected grouping of beverages showing fulfilled and outstanding ordered beverages in accordance with embodiments of the invention.

FIG. 5 depicts a business-side application screen showing ordered beverages that have been indicated as fulfilled in accordance with embodiments of the invention.

FIG. 6 depicts a method for providing efficient customer ordering and service in a hospitality business incorporating computer-implemented means.

FIG. 7 depicts a computer-implemented method for providing efficient organization and satisfaction of customer orders in a hospitality business.

FIG. 8 depicts a computer-implemented method for providing an estimate of hospitality business's degree of occupancy.

The images in the drawings are simplified for illustrative purposes and are not depicted to scale. Within the descriptions of the figures, similar elements are provided similar names and reference numerals as those of the previous figure(s). The specific numerals assigned to the elements are provided solely to aid in the description and are not meant to imply any limitations (structural or functional) on the invention.

The appended drawings illustrate exemplary configurations of the invention and, as such, should not be considered as limiting the scope of the invention that may admit to other equally effective configurations. It is contemplated that features of one configuration may be beneficially incorporated in other configurations without further recitation.

### DETAILED DESCRIPTION

The embodiments of the disclosure will be best understood by reference to the Figures, wherein like parts are designated by like numerals throughout. It will be readily understood that the components, as generally described and illustrated in the Figures herein, could be arranged and designed in a wide variety of different configurations or be entirely separate. Thus, the following more detailed description of the embodiments of the system of the disclosure, as represented in the Figures is not intended to limit the scope of the disclosure, as claimed, but is merely representative of possible embodiments of the disclosure.

The following description sets forth numerous embodiments and parameters. It should be recognized, however, that such description is not intended as a limitation on the scope of the present invention but is instead provided as a description of exemplary embodiments. Various modifications to the examples described will be readily apparent to those of ordinary skill in the art, and the general principles defined may be applied to other examples and applications without departing from the spirit and scope of the invention. Thus, the present invention is not intended to be limited to the examples described herein but is to be accorded a scope consistent with the claims.

The present invention is a system for improving the efficiency of many aspects of a service industry business that utilizes a mobile, computer or web-based application. The aspects of a service industry business that may be improved by the system include the ordering process, the efficiency of preparation of beverages and other items, the payment process, the tracking and planning of inventory and the delivery of items to customers. In the preferred embodiment, the application is used in a bar and/or restaurant setting. The application generally provides two different sets of functions based on the different type of user: a customer or a business. In some embodiments the system is implemented through two separate applications, a customer side application and business side application. In some embodiments, both the customer side application features and the business-side application features are accessible via a single application. The business side of the application or the distinct business side application is operable to perform one or more of the following actions: receive, categorize and queue orders, communicate with customers, receive payment, issue refunds, offer promotions and advertisements and compile customer and business data, etc. The customer-side of the application or the distinct customer side application is operable to perform one or more of the following actions: view and select local service industry businesses, view the occupancy and expected wait-times for service at those local service industry businesses, place orders, make payment for orders, pay an additional tip, receive orders from staff members or a pickup location, confirm order fulfillment, view promotions and deals, etc.

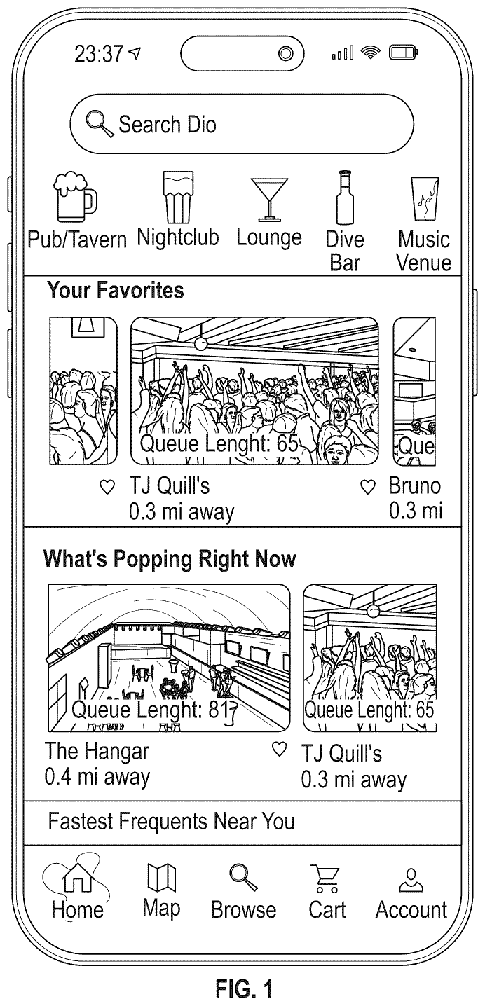

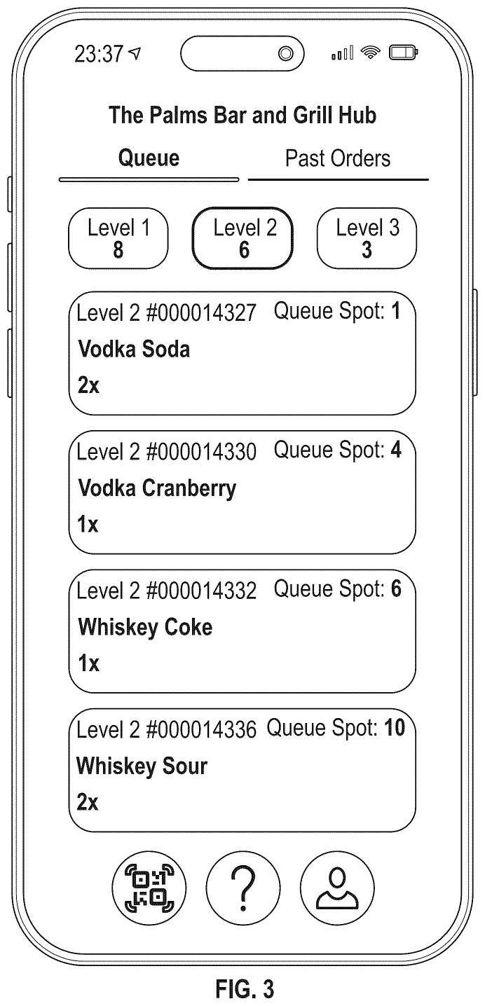

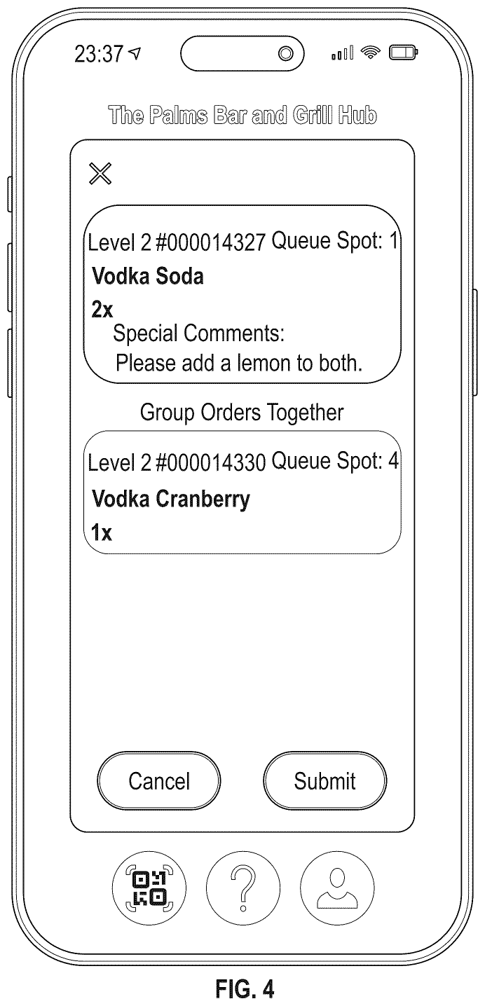

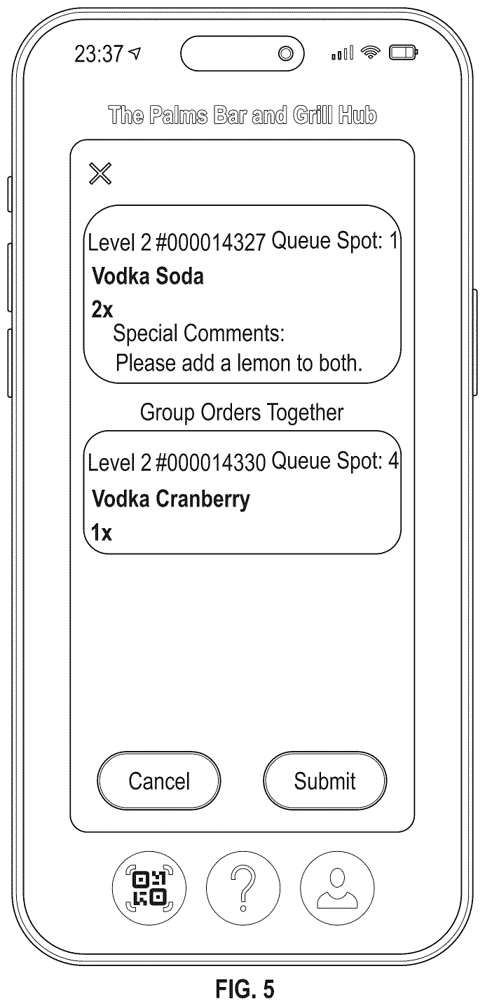

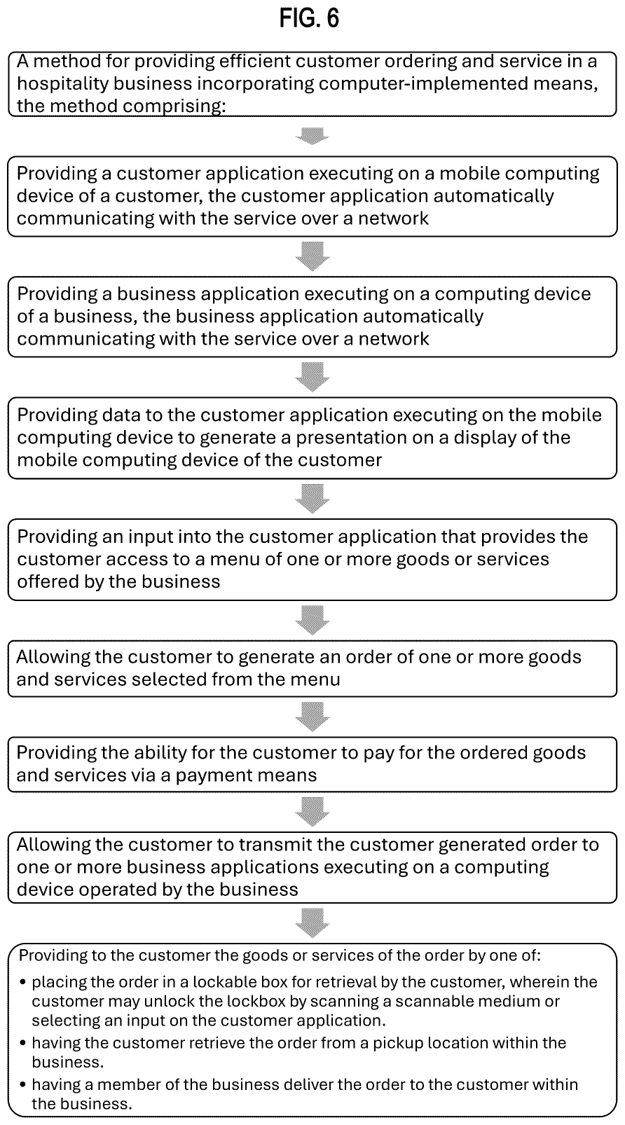

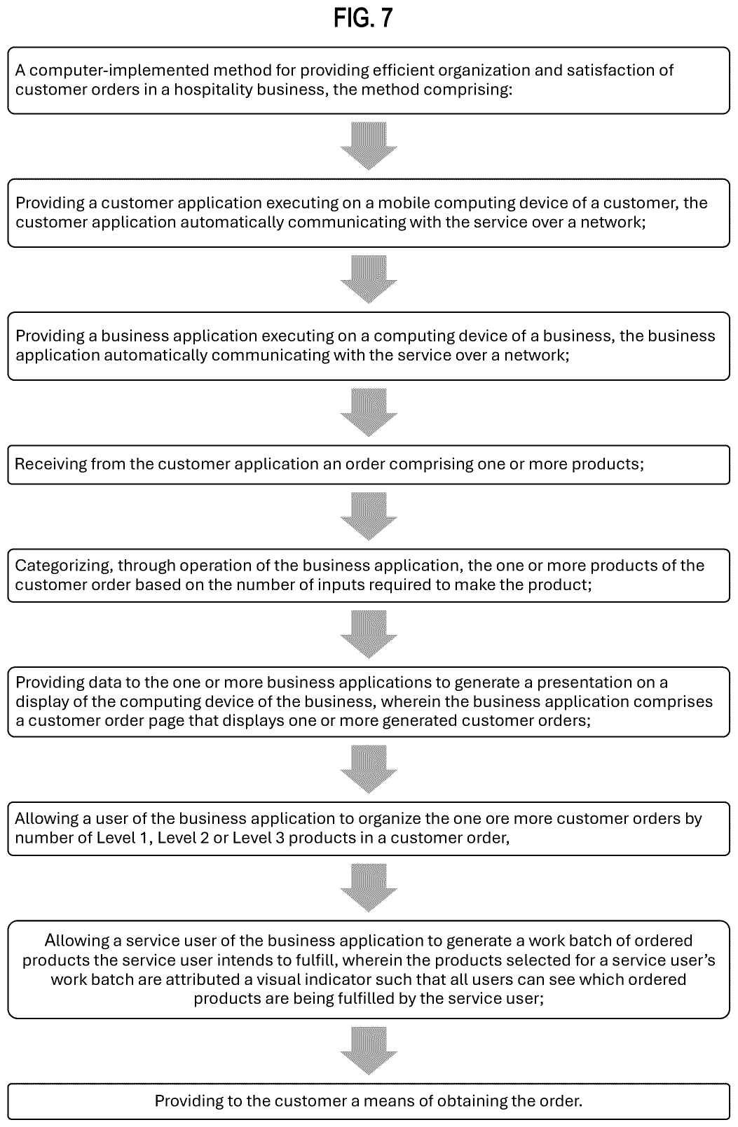

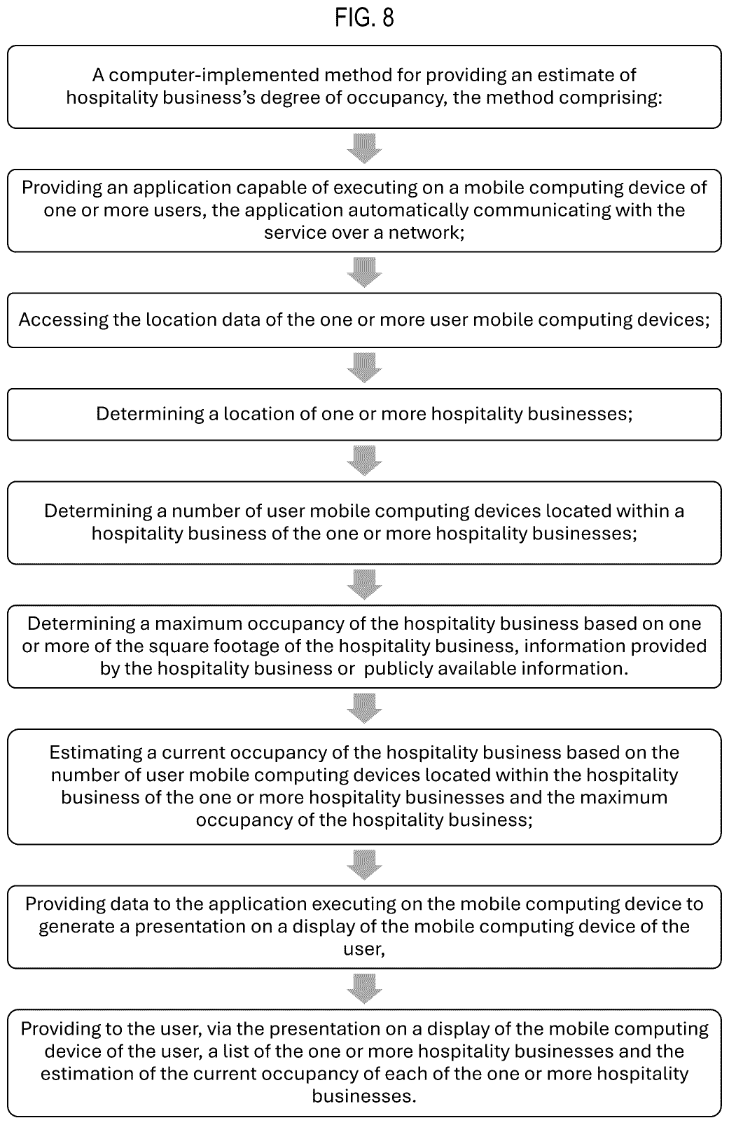

The mobile, web or computer applications comprise several graphical interfaces that allow users to access the service and various functions of the application. Examples of the graphical interfaces are shown in FIGS. 1-8. The customer side application(s) may execute on a mobile device, tablet or computing device of a customer which automatically communicates over a network. The business side application may execute on a mobile device, tablet or computer device of a business and/or the mobile devices, tablet or computer devices of one or more staff members of that business.

The customer side application may require customers to create an account that includes identifying information, login information and payment information, such as a credit card, bank account, etc. In some embodiments of the invention, a customer may have to verify that they are of legal drinking age to use the application and service. The account may allow customers to create a profile that can be used for social media purposes. A customer's profile may include food, beverage and atmosphere preferences such that the application may more effectively suggest food, beverages and businesses to the customer.

The business side application requires businesses to create a main account for the business. The main business account includes business, owner, menu and payment information. The business side application may further require each staff member to create an individual account. The individual staff accounts are linked to the business account such that they can interact with a central customer order queue and other functions of the main business account. Customer side and business side applications may interface with the GPS and/or location functionalities of the device that the applications in order to provide location-based suggestions, services and functions.

A customer may link their application to a specific bar or restaurant by scanning a scannable medium (for example, a QR-code, barcode, etc.), selecting the bar or restaurant through a list, searching for the bar or restaurant through a search function, or by selecting a specific bar or restaurant that the application suggests to the customer based on the customer's location.

The application may use location data of application users to provide customers with estimates of occupancy and wait times of each bar or restaurant. Customers can know beforehand whether a bar may be too crowded or not lively enough. In some embodiments, a score, tag or indicator is listed next to each bar or restaurant name to indicate the occupancy, liveliness and/or wait-time of that bar, restaurant or other hospitality business. In some embodiments, the application may include a tab, screen or graphical interface dedicated to indicating which bars or restaurants in a geographical area are the most or least crowded. An example of the graphic presentation dedicated to a list of local venues and their occupancy is depicted in FIG. 1.

After the bar or restaurant is selected by a customer, the application presents the customer with a menu of items that may include a price and description of the item. The application may also provide an estimated wait-time for current orders based on any number of factors such as the bar traffic, amount of current outstanding orders, customer order size, average historical wait-times, number of staff, etc. If the customer has previously used the application to order, the application may provide the option of re-ordering a previous order. The application may suggest certain menu items to customers based on what items are most popularly ordered at a particular business, a customer's order history or preferences, or deals, discounts or promotions offered by the business.

After menu items are selected for purchase, the application may provide a means of customizable input for one or more order items so that customers may provide specific instructions and special requests for their orders.

After the order is finalized, the customer-side application brings the customer to a payment screen that allows for payment of the order. The payment screen provides the option of adding an additional tip. Conducting the payment transaction via the application eliminates another time-consuming aspect of the service process for the staff member and further increases the efficiency and speed of the bar or restaurant ordering and serving process.

After payment is completed by a customer, the application directs the customer to an after-order screen. The after-order screen may include an order tracking feature that provides the customer with an estimated wait-time and/or information regarding the progress of the order. The after-order screen may further include an option to split payment among other application customers by sending a contribution request to other mobile devices, computers, etc. The contribution request may be sent directly from one customer application to another customer application or by SMS, email, or any other method known in the art. The amount of contribution requested can modified by the ordering customer based on a percentage of the whole order payment or a based on the costs of one or more specific order items.

After payment has been completed by a customer, the service operates to transmit the customer's order to the business-side application of the subject business. The service provides a useful categorization and queuing function on the business side of the application by grouping beverage items across multiple different customer orders into groups of similar items and allowing staff members to efficiently fulfill portions of multiple customer orders at the same time.

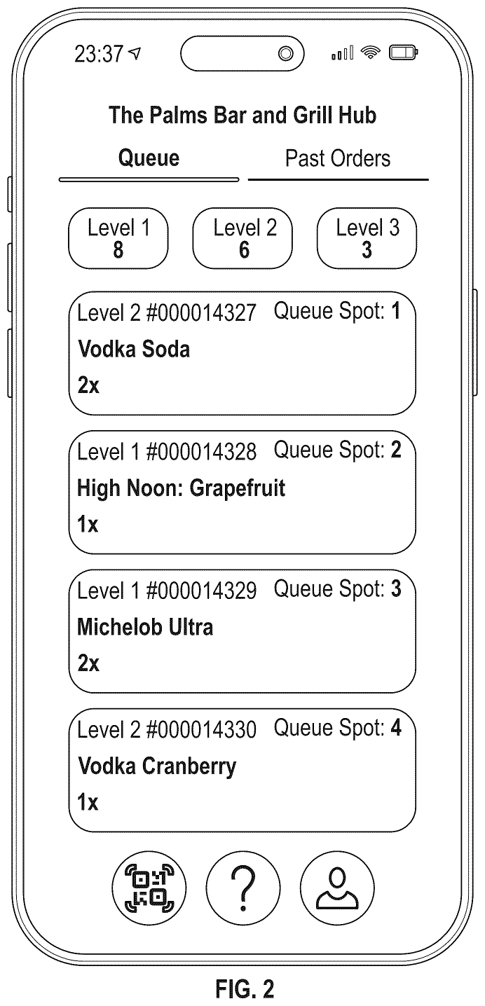

In one embodiment of the invention the different beverage groups are referred to as levels. Level 1 includes drinks that do not require mixing of ingredients, such as canned, bottled or draft beverages, such as beer or soda, and pours of alcohol such as shots, neat pours and pours over ice. Level 2 includes beverages that require mixing only a few ingredients or less (for example, 3 or less ingredients). Beverages in Level 2 may include, for example, a pour of alcohol and a mixer or a mixture of a Level 1 drink and another ingredient. Level 3 includes any offered beverage that is not categorized as Level 1 or Level 2 and typically includes more complex cocktails. While the application may provide suggested categorizations for commonly known menu items, each business may customize the categorization of its menu items to best fit their needs. FIGS. 2-5.

FIG. 2-5 depict examples of a business application's graphic presentation of outstanding customer orders and the organization of customer orders based on menu item Levels.

The application allows staff members to queue customer orders in customizable and efficient ways based on the categorization process, such as listing all of the customer orders by complexity (number of different type or level of beverage), beverage level, total beverage number, number of beverages in a specific level, chronological order of order receipt, etc. For example, the application is operable to arrange and queue the outstanding customer orders based on which orders have the fewest beverages categorized as Level 3. In another example, a staff member may select that the application only displays customer orders containing 4 or fewer total beverages.

The application may also show the total number of Level 1, 2 or 3 drinks across all outstanding orders. This allows staff members to prepare multiple orders by beverage type as opposed to per order. Additionally, one or more staff members may focus on a single category of drinks while other staff members collect completed drinks and organize them into completed customer orders. The application may allow for staff members to first select a group of one or more customer orders and then further arrange the selected orders by order complexity, beverage category, total beverage number, number of beverages in a specific category, chronological order, etc.

The application may further allow for each staff member, through their individual application account, to create an individual work batch. The staff member can select one or more orders or one or more individual ordered beverages from the drink queue and place them in a work batch. The beverages and orders in the customer order queue that have been placed in a work batch are given a work batch indication so that other staff members can see which beverages in the customer order queue are already being prepared. A work batch indication may note which individual staff member has the beverages in their work batch.

The application allows for the status of each beverage to be designated as “completed,” such that when multiple staff members are working together, each staff member may see which portions of outstanding orders have been fulfilled. The application allows for the status of each customer order to be designated as fulfilled or outstanding. In some embodiments of the invention, the fulfilled and outstanding orders are located in separate lists, screens or graphical interfaces. In some embodiments of the invention, the customer orders automatically change status to indicate they are fulfilled when a staff member secures the order into a lockbox. The transmission for an automatic status update may be facilitated by a staff member scanning a scannable medium of the specific lockbox. A scannable medium may be a QR-code, barcode or any other suitable means.

The prioritization of less complex customer orders may help staff members efficiently serve the largest number of customers possible. The categorization and queuing processes also help staff members efficiently make multiple orders at once by avoiding repeated trips to the same bar or kitchen station. Staff members can identify and select certain types of beverages across multiple orders, allowing them to utilize efficiency of motion by fulfilling multiple orders, or portions of multiple orders, in a single visit to a bar station. For example, if there are four outstanding customer orders, the staff member may use the service to identify that there are six Level 1 beverages across the four outstanding orders. The staff member may use the service to see only the queued Level 1 beverages and then make a single trip to collect all six Level 1 beverages. This method reduces the number of trips for the staff members from four separate trips (one for each customer order) to a single trip.

The application further provides an order cancellation function that staff members may use to cancel orders and, if necessary, refund customer payments. The order cancellation function may allow staff members to choose from a list of common reasons for cancellation. In some embodiments, the order cancellation function allows staff members to input a custom message (via a text box) as to the reason for order cancellation.

When an order is completed by the business, the customer-side application may provide an alert or notification to the customer. In some embodiments of the invention, the customer is directed to a location in the bar or restaurant to pick up their order. In some embodiments of the invention, a completed order is delivered to a customer by an employee of the business via instructions provided through a business-side application. In some embodiments of the invention, a specific table (such as a table number) or location is attributed to the customer's order so that a staff member may bring the completed order to the customer.

In some embodiments, the completed orders are placed in one or more lockboxes for pickup by the ordering customer. An employee of the business may secure the completed order in a lockbox and report which lockbox contains the customer's order via the business side application. The correct lockbox is relayed to the customer through the customer side application. The customer may open the lockbox by scanning a scannable medium such as a barcode or QR-code or by inputting a code or password provided by the application. The lockbox ensures customers receive their orders and prevents theft.

In some embodiments, the application may provide a virtual queue system for customers to approach the bar to place an order in an orderly fashion. Customers may use their application to secure a place in a queue of customers by receiving a number. Then staff members may call each customer up to the bar in an orderly fashion based off queue number. This method prevents unorderly crowding of the bar by multiple customers, while still allowing customers to interact with staff members and ask questions or receive recommendations.

The application tracks customer orders including the specific items ordered, the Level of beverages ordered, the total number of beverages ordered, the date and time of orders, the time it takes for an order to be completed by staff, etc. This allows for business side application users to track trends, identify peak times and dates, quantify occupancy, track and optimize inventory and curate promotions and pricing.

In some embodiments, the application may provide artificial intelligence or machine learning to perform one or more functions. In some embodiments, the application may provide artificial intelligence may be incorporated to more accurately calculate wait times for customers. The artificial intelligence program may be in communication with the customer and business side applications via a network. The artificial intelligence (AI) program may approximate the occupancy and or the expected wait time of a potential order by detecting the number of mobile devices present in a business location, the wait times experienced by customers from order placement to order receipt, and/or the time it takes for the business to complete an order. The AI may detect the number of mobile devices present in a business location by accessing the GPS or location services of the mobile devices having the customer side mobile app downloaded.

In some embodiments, an artificial intelligence (AI) program may be used one a business-side device application to analyze outstanding order and group or organize similar menu items of various orders together. In some embodiment, and artificial intelligence (AI) program may be used analyze the outstanding customer orders and suggest options for different groupings of individual menu items across multiple different customer orders. In some embodiment, an AI program can assess a current entire customer order log of the business side application and make suggestions for efficient order fulfillment and delivery, such as suggesting a server wait to pick up an order from a kitchen because another order is nearing completion, thereby helping the server efficiently pickup multiple orders in a trip as opposed to single orders. Or, in another example, suggestions menu items for server preparation based on proximity of ingredients necessary for preparation. In some embodiment, the AI program can recommend delivering one or more customer orders based on customer proximity within the bar, such that the server can reduce time spent navigating across a crowded bar or restaurant.

In some embodiments, an artificial intelligence (AI) program may be used to help market business goods and services to customers. In some embodiments, an artificial intelligence (AI) program may be used detect and analyze the menu items and services a customer user has ordered in the past, from the same or different businesses in the app, and may suggest to the customer user a goods or services that are similar or fit the customer user's tastes. In some embodiments, an artificial intelligence (AI) program may be used to develop a customer user profile, individual to each customer user, that takes into account their food and drink preferences, taste and ingredient preferences, value and price preferences, order timing, order sequence and other factors.

In some embodiments, an artificial intelligence (AI) program may be used to help business users to analyze customer order data for a respective business and provide suggestions to business users regarding customer order trends at specific times, on specific days or around specific events and holidays. The artificial intelligence (AI) program may be configured to help business users analyze customer orders to identify popularity of menu items, suggest promotions or advertisements for specific items, suggest discontinuing specific items, assist in restocking items or ingredient inventory and anticipating item or ingredient shortages.

This invention and disclosure teach and anticipate incorporating as a part of the methods disclosed, a function of providing the AI within a customer or business mobile application or connected thereto by means known in the art, having the AI analyze one or more sets of information used or tracked by the customer or business computer application and providing an analysis and/or suggestion based on that analysis to a customer or business user. This invention and disclosure teach and anticipate incorporating as a part of the methods disclosed the AI functions discussed above.

In some embodiments, a method for providing efficient customer ordering and service in a hospitality business incorporating computer-implemented means is provided. The method comprises the steps of providing a customer application executing on a mobile computing device of a customer, wherein the customer application automatically communicates with a service over a network. The method further comprises the step of providing a business application executing on a computing device of a business, wherein the business application automatically communicates with a service over a network. The method further comprises providing data to the customer application executing on the mobile computing device to generate a presentation on a display of the mobile computing device of the customer. The method may further comprise providing a customer access to a menu of one or more goods or services offered by the business. In some embodiments, customer access to a business menu is granted only by having the customer user provide a business specific input in the application such as selecting the business from a list, inputting a passcode or scanning a scannable medium (QR code, barcode, etc.) or having the geolocation of the mobile device be within an area designated by the business or application. The method may further comprise allowing a customer to generate an order of one or more goods and services selected from a business menu and then providing a means for the customer to pay for the ordered goods and services such as a payment screen that allows for customer to input credit card information, or another electronic payment means well known in the art. The method may further comprise transmitting the customer generated order to one or more business applications executing on a computing device operated by the business. In some embodiments, the customer generated order may only be transmitted to a business that customer's mobile device is within a certain geographical proximity of, i.e. the customer user's device is in the business (or nearby). The method may further comprise providing to the customer the goods or services of the order by one, or a combination of, having an employee of the business (business user) place the order in a lockable box for retrieval by the customer, having the customer retrieve the order from a pickup location within the business (such as a designated table, counter or portion of a bar), and/or having an employee of the business deliver the order to the customer within the business. If the order is delivered to a lockbox for pickup, the customer may then unlock the lockbox to retrieve their order by scanning a scannable medium, selecting an input on the customer application, inputting a passcode or other means known in the art.

In some embodiments of the method for providing efficient customer ordering and service in a hospitality business incorporating computer-implemented means, the method may include a process of verifying a customer and/or a customer's mobile device, is located within, or within a certain proximity of, the business they are ordering from. The step of user location verifications may include the steps of determining the current location of the mobile computing device of the customer and determining a location of the business.

In some embodiments of the method for providing efficient customer ordering and service in a hospitality business incorporating computer-implemented means, the method may further comprise the step of allowing the customer to generate an order of one or more goods and services selected from the business's menu only if the location of customer and/or a customer's mobile device is within or immediately nearby the location of the business. The method may further comprise the step of having the customer application provide a notification to the customer when the order has been completed by the business or is designated as completed on the business side application.

In some embodiments, a computer-implemented method for providing efficient organization and satisfaction of customer orders in a hospitality business is disclosed. A computer-implemented method for providing efficient organization and satisfaction of customer orders in a hospitality business may comprise the steps of providing a customer application executing on a mobile computing device of a customer, wherein the customer application automatically communicates with a service over a network. The method may further comprise the step of providing a business application executing on a computing device of a business, the business application automatically communicating with the service over a network. The method may further comprise= the step of receiving from the customer application an order comprising one or more menu items. The method may further comprise the step of categorizing the one or more menu items of the customer order based on the number of inputs required to make the menu item, via operation of the business application, and/or the service provided on the network. The method may further comprise the step of providing data to the one or more business applications to generate a presentation on a display of the computing device of the business, wherein the business application comprises a customer order page that displays one or more generated customer orders. The method may further comprise the step of allowing a user of the business application to organize the one or more customer orders by number of Level 1, Level 2 or Level 3 menu items in a customer order. In some embodiments, the groups of Level 1, Level 2 or Level 3 are defined by number of ingredients in a menu item such that menu items that require one ingredient are Level 1, menu items that require two to three ingredients are Level 2 and menu items that require three or more ingredients are Level 3. In some embodiments, the groups of Level 1, Level 2 or Level 3 are defined by a business user's designation of menu items as a Level 1 menu item, a Level 2 menu item or a Level 3 menu item within the business application. In some embodiments, the groups of Level 1, Level 2 or Level 3 are defined by complexity of the menu item preparation wherein menu items that do not require additional preparation as Level 1, grouping menu items that require preparation involving two to three ingredients as Level 2 and grouping menu items that require preparation involving three or more ingredients as Level 3. The method may further comprise allowing a user of the business application to generate a work batch of ordered menu items the business user intends to fulfill, wherein the menu items selected for a business user's work batch are attributed a visual indicator such that all business users can see which ordered menu items are being currently fulfilled. The method may further comprise providing to the customer a means of obtaining the order. The method may further comprise the step of collecting data regarding customer orders, including the number of times a menu item is ordered, the number of items of a specific Level ordered and the times that menu items are ordered. The method may further comprise the step of providing artificial intelligence in communication with the customer application, wherein the artificial intelligence analyzes the data regarding customer order and providing to the user of the business application, one or more analysis of the data regarding customer order. The method may further comprise the step of assessing an estimated time for customer order fulfillment based on a duration of time from the business application receiving a customer to the customer obtaining the order, for one or more customer orders. The method may further comprise the step of providing a customer application executing on a mobile computing device of a customer, the customer application automatically communicating with the service over a network, providing, via the customer application communicating with the service over a network, the business's estimated time for customer order fulfillment of one or more businesses.

A computer-implemented method for providing an estimate of hospitality business's degree of occupancy, the method comprising the step of providing an application capable of executing on a mobile computing device of one or more users, the application automatically communicating with the service over a network. The method may further comprise the step of accessing the location data of the one or more user mobile computing devices. The method may further comprise the step of determining a location of one or more hospitality businesses and determining a number of user mobile computing devices located within a hospitality business of the one or more hospitality businesses. The method may further comprise the step of determining a maximum occupancy of the hospitality business based on one or more of the square footage of the hospitality business, information provided by the hospitality business or publicly available information. The method may further comprise the step of estimating a current occupancy of the hospitality business based on the number of user mobile computing devices located within the hospitality business of the one or more hospitality businesses and the maximum occupancy of the hospitality business. The method may further comprise the step of providing data to the application executing on the mobile computing device to generate a presentation on a display of the mobile computing device of a customer user. The method may further comprise the step of providing to the customer user, via the presentation on a display of the mobile computing device of the customer user, a list of the one or more hospitality businesses and the estimation of the current occupancy of each of the one or more hospitality businesses.

For the purposes of promoting an understanding of the principles of the invention, reference has been made to the preferred embodiments illustrated in the drawings, and specific language has been used to describe these embodiments. However, this specific language intends no limitation of the scope of the invention, and the invention should be construed to encompass all embodiments that would normally occur to one of ordinary skill in the art. The particular implementations shown and described herein are illustrative examples of the invention and are not intended to otherwise limit the scope of the invention in any way. For the sake of brevity, conventional aspects of the system (and components of the individual operating components of the system) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

1. A method for providing efficient customer ordering and service in a hospitality business incorporating computer-implemented means, the method comprising:
a. providing a customer application executing on a mobile computing device of a customer, the customer application automatically communicating with the service over a network;
b. providing a business application executing on a computing device of a business, the business application automatically communicating with the service over a network;
c. providing data to the customer application executing on the mobile computing device to generate a presentation on a display of the mobile computing device of the customer,
d. providing the customer access to a menu of one or more goods or services offered by the business,
e. allowing the customer to generate an order of one or more goods and services selected from the menu;
f. providing the ability for the customer to pay for the ordered goods and services via a payment means;
g. allowing the customer to transmit the customer generated order to one or more business applications executing on a computing device operated by the business;
h. providing to the customer the goods or services of the order by one of:
i. placing the order in a lockable box for retrieval by the customer, wherein the customer may unlock the lockbox by scanning a scannable medium or selecting an input on the customer application.
ii. having the customer retrieve the order from a pickup location within the business.
iii. having a member of the business deliver the order to the customer within the business.

2. The method of claim 1, wherein after step (b), the method further comprises the steps of determining a current location of the mobile computing device of the customer;
determining a location of the business.

3. The method of claim 2, wherein after step (h), the method further comprises the step of allowing the customer to generate an order of one or more goods and services selected from the menu only if the customer mobile computing device is within or immediately nearby the location of the business.

4. The method of claim 1, wherein after step (h), the method further comprises the step of having the application provide a notification to the customer when the order has been completed.

5. The method of claim 1, wherein the scannable medium is one of a QR code or a barcode.

6. The method of claim 1, further comprising the step of providing an artificial intelligence in communication with the customer application, wherein the artificial intelligence analyzes a customer order;
Providing to the customer, within the customer service application, one or more recommendations of goods and services from the businesses' menu based the artificial intelligence analysis.

7. A computer-implemented method for providing efficient organization and satisfaction of customer orders in a hospitality business, the method comprising:
a. providing a customer application executing on a mobile computing device of a customer, the customer application automatically communicating with the service over a network;
b. providing a business application executing on a computing device of a business, the business application automatically communicating with the service over a network;
c. receiving from the customer application an order comprising one or more menu items;
d. categorizing, through operation of the business application, the one or more menu items of the customer order based on the number of inputs required to make the menu item;
e. providing data to the one or more business applications to generate a presentation on a display of the computing device of the business, wherein the business application comprises a customer order page that displays one or more generated customer orders;
f. allowing a user of the business application to organize the one or more customer orders by number of Level 1, Level 2 or Level 3 menu items in a customer order,
g. allowing a business user of the business application to generate a work batch of ordered menu items the service user intends to fulfill, wherein the menu items selected for a business user's work batch are attributed a visual indicator such that all users can see which ordered menu items are being fulfilled by the business user;
h. providing to the customer a means of obtaining the order.

8. The method of claim 7, wherein categorizing the one or more menu items comprises grouping menu items that require one ingredient as Level 1, grouping menu items that require two to three ingredients as Level 2 and grouping menu items that require three or more ingredients as Level 3.

9. The method of claim 7 wherein categorizing the one or more menu items comprises grouping menu items based on a user's designation of menu items as a Level 1 menu item, a Level 2 menu item or a Level 3 menu item within the business application.

10. The method of claim 7, wherein categorizing the one or more menu items comprises grouping menu items that do not require additional preparation as Level 1, grouping menu items that require preparation involving two to three ingredients as Level 2 and grouping menu items that require preparation involving three or more ingredients as Level 3.

11. The method of claim 7, wherein the menu items are food, beverage or alcoholic beverage menu items.

12. The method of claim 7, further comprising the step of collecting data regarding customer orders, including the number of times a menu item is ordered, the number of items of a specific Level ordered and the times that menu items are ordered.

13. The method of claim 12, further comprising the step of:
i. providing an artificial intelligence in communication with the customer application, wherein the artificial intelligence analyzes the data regarding customer order;
j. providing to the user of the business application, one or more analysis of the data regarding customer order.

14. The method of claim 7, further comprising the step of assessing an estimated time for customer order fulfillment based on a duration of time from the business application receiving a customer to the customer obtaining the order, for one or more customer orders.

15. The method of claim 14, further comprising the steps of:
providing a customer application executing on a mobile computing device of a customer, the customer application automatically communicating with the service over a network,
providing, via the customer application communicating with the service over a network, the business's estimated time for customer order fulfillment of one or more businesses.

16. A computer-implemented method for providing an estimate of hospitality business's degree of occupancy, the method comprising:
(a) providing an application capable of executing on a mobile computing device of one or more users, the application automatically communicating with the business user over a network;
(b) accessing the location data of the one or more user mobile computing devices;
(c) determining a location of one or more hospitality businesses;
(d) determining a number of user mobile computing devices located within a hospitality business of the one or more hospitality businesses;
(e) determining a maximum occupancy of the hospitality business based on one or more of the square footage of the hospitality business, information provided by the hospitality business or publicly available information.
(f) Estimating a current occupancy of the hospitality business based on the number of user mobile computing devices located within the hospitality business of the one or more hospitality businesses and the maximum occupancy of the hospitality business;
(g) providing data to the application executing on the mobile computing device to generate a presentation on a display of the mobile computing device of the user,
(h) providing to the user, via the presentation on a display of the mobile computing device of the user, a list of the one or more hospitality businesses and the estimation of the current occupancy of each of the one or more hospitality businesses.
